(19) United States
(12) Patent Application Publication
(10) Pub. No.: US 2006/0125309 A1
(43) Pub. Date: Jun. 15, 2006

(54) Universal wheel

(76) Inventors: Shanjun Huang, Fuzhou City Fujian Province (CN); Jiangyi Zhao, Fuzhou City Fujian Province (CN); Changjiang Huang, Fuzhou City Fujian Province (CN)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(21) Appl. No.: 10/542,973

(22) PCT Filed: Aug. 27, 2003
(86) PCT No.: PCT/CN03/00723

§ 371 Date: Jul. 21, 2005

(51) Int. Cl. B60B 1/00; B60B 27/00

(52) U.S. Cl. 301/5.23

(57) ABSTRACT

The invention relates to the structure and the shape of a kind of new universal wheel, which comprises of drum-shaped rollers, bat-shaped brackets, mandrels, side panels, bearings, a central shaft and a wheel carrier. It characterizes in that the drum-shaped rollers and the mandrels from a rim by fixed in the bat-shaped brackets, and the bat-shaped brackets are connected to the side panels, the bearings, the central shaft and the wheel carrier are fixed on the center of the side panel. Since the big and small drum-shaped rollers form a double freedom structure, the wheel can move in any direction without turning so that it can save the turning space. Moreover this kind of universal wheel has good sealing performance, the sand will not enter the inner chamber.

### THE TECHNICAL FIELD

The present invention relates to the structure and shape of a universal wheel, and more particularly, relates to a novel structure and shape of a universal wheel which can be moved to any direction with the action of the outside force without rotation of the wheel.

### THE BACKGROUND OF THE ART

In regard to the conventional universal wheel, it could be moved along the direction of the applied outside force under the condition when its wheels rotate to the same direction as that of the outside force, when the outside force changes its moving direction, the above conventional universal wheel requires a process for adjusting the direction of the wheels, which leads to the swaying phenomena during use and is not flexible, in addition, the direction of the applied load in the conventional universal wheel deflects a certain distance from the center of the wheels, which causes the wheel carrier with big deflection moment and affects the life of the wheel carrier, and conventional universal wheel also needs the installation space for making the wheels to rotate around the vertical shaft of the wheel carrier.

The present inventor has ever applied three patent applications dated on December in 2002, that are: utility model:02291781, patent for invention: 002130670.2 and PCT application: PCT/CN02/00880, with the same structure and title “A novel universal wheel”, the technical scheme of them is to install Y-shape bracket onto the small drum-shaped roller, but that has the following disadvantages: this kind of bracket has to pass through the interspace between the two big drum-shaped rollers and to be fixed into the central position of the half hubcap grooves, such kind of structure shall make the wheel not to be fit for mounting other elements at the central part thereof, such as the rolling bearings, the spacing at the end face of the big drum-shaped roller of the joint between the big and small drum-shaped rollers is bigger, which is easy be entry by dust and to affect the rotation of the big and small rollers, and also the structure and technics of the half hubcap at the two sides are complicated resulting in higher machining cost.

As shown by the related patent searching results, there is still not any report concerning the universal wheel which could be moved to any direction with the action of the outside force without rotation of the wheels during use of the single arrays of rollers.

The Inventive Content

The present invention provides a kind of novel universal wheel which could overcome the defects occurred in the existing universal wheel in regard to the structure, performance, installation and the use.

The technical scheme of the present invention for overcoming the technical problem is as follows: a kind of novel universal wheel consists of big and small drum-shaped rollers, bat-shaped brackets, long and short mandrels, side panels, bearings, a central shaft and a wheel carrier, which is characterized that the outer edge of the wheels is the wheel rim constituted by big and small drum-shaped rollers; a long mandrel is disposed at the center of the small drum-shaped roller and which is installed on the bat-shaped brackets, the lower parts of the left and right side of the bat-shaped brackets are each provided with one shaft hole respectively for fitting the short mandrels of the big drum-shaped roller, which makes the small drum-shaped roller to rotate freely on the bat-shaped bracket, while the big drum-shaped roller is fit over the short mandrel, since the two ends of the big drum-shaped roller are provided with the grooves for inserting the left end or the right end of the bat-shaped brackets and the big drum-shaped roller is supported between the two bat-shaped brackets, thus the big drum-shaped roller could be rotated freely; the big and small drum-shaped rollers are supported by the bat-shaped brackets and constitute the wheel rim; the bearings are provided at the center of the side panels and with the center of the bearings as the central shaft installing wheel carrier there on, as a result the universal wheel is formed by the above. The said left end of the long mandrel is the shaft head in half-moon shape fitted with the same shape shaft hole on the base at the left side of the bat-shaped bracket, and the shaft hole at the right base of the bat-shaped bracket is connected with the shaft head of the long mandrel and to be riveted together. The shaft heads at the two ends of the short mandrel are machined into half-moon shape to be connected with the shaft holes in the same shape at the tilted lower part of the bat-shaped brackets. The two sides at the middle part of the said bat-shaped brackets are provided with protruding stages in flat trapezia shape, and also the groove holes in flat trapezia shape are provided at the two side panels in the corresponding positions with the above flat protruding stages on the bat-shaped brackets, in such a way the big and small drum-shaped rollers, the bat-shaped brackets and the long and short mandrels are assembled along the circumference direction as a single line, the two side panels are inserted into flat trapezia shape protruding stages, as a result the big and small drum-shaped rollers and the bat-shaped brackets are fixed between the two side panels. The said big and small drum-shaped rollers are three to thirty pairs. Three or four universal wheels of the present invention are mounted onto the carriers while being used, which could make the carrier to be pushed to any direction.

The advantages of the present inventions are as follows: the universal wheel of the present invention could be pushed to any direction without rotation of the wheels in use, since the rim of it is provided with the big and small drum-shaped rollers which form the double freedom structure, therefor it saves the rotation space for rotation, and also the universal wheel of the present invention is forced evenly and without eccentricity moment, therefor it is used in long time. Since the present invention has overcome the disadvantages existed in the patents 02130670, 02291781.0 and PCT/CN02/00880, it is in reasonable structure and runs stable without noise due to the small gap, that is only 1 mm, between the big and small drum-shaped rollers. In addition, the universal wheel of the present invention is in good airproof, which could prevent the dust from entering into the inner chamber of the rollers, therefor the universal wheel of the present invention is in reasonable structure, with good technics, convenient for installation, with long life and lower cost.

### THE DESCRIPTION OF THE DRAWINGS

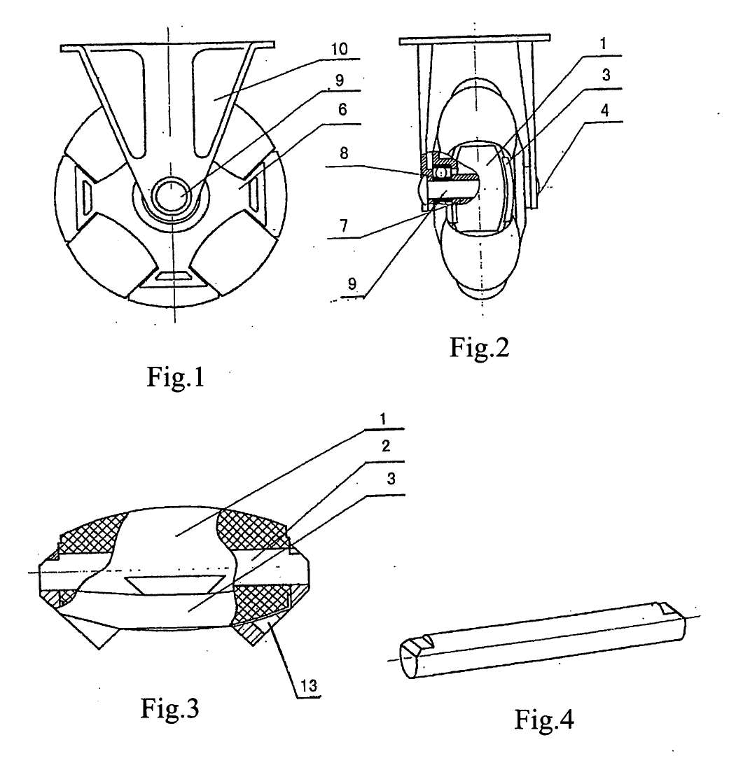

The FIG. 1 is the general front view of the present invention;

The FIG. 2 is the general left view of the present invention;

The FIG. 3 is sectional views of the assembled small drum-shaped roller, the long mandrel and the bat-shaped brackets;

The FIG. 4 is the structural view of the long mandrel of the present invention;

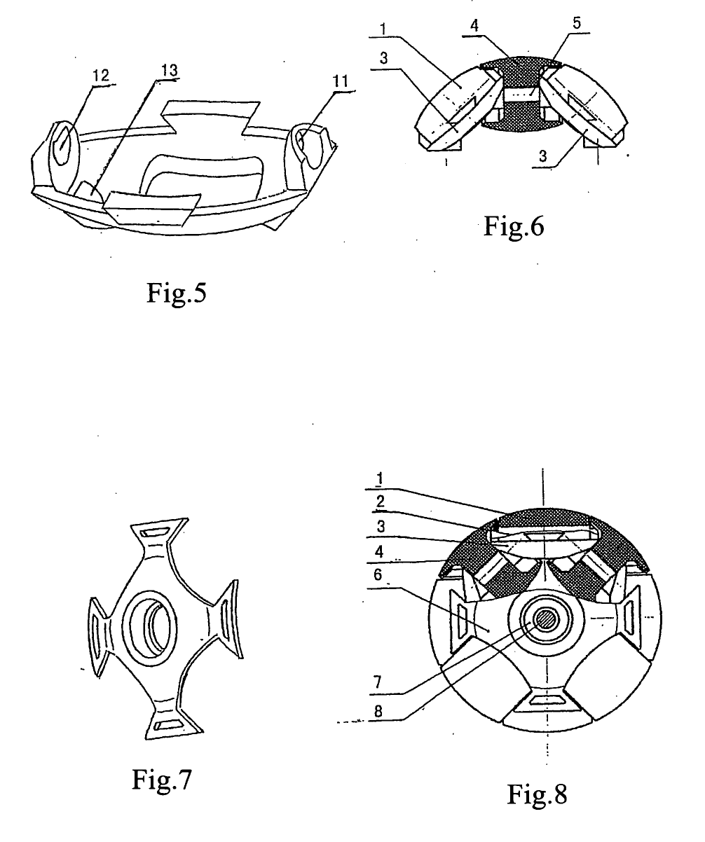

The FIG. 5 is perspective structural view of the bat-shaped brackets of the present invention;

The FIG. 6 is the sectional views of the assembled small drum-shaped roller, bat-shaped brackets and the big drum-shaped brackets;

The FIG. 7 is the perspective view of the side panel of the present invention; and

The FIG. 8 is partial sectional view of the universal wheel of the present invention.

### THE PREFERRED EMBODIMENTS

Referencing the FIGS. 1-8, the FIG. 1 shows the technical scheme of the novel universal wheel consisted of four pairs of the big and small drum-shaped rollers. The shaft heads of at the two ends of the long mandrel 2 is formed in half moon shape, refer to FIG. 4. The long mandrel 2 is passed through the shaft hole 11 at the right base of the bat-shaped bracket 3, and then it passed into the central hole of the small drum-shaped roller 1, and finally it is inserted into the half moon shaft hole 12 at the left base of the bat-shaped bracket 3, referencing the FIGS. 5 and 3, thus the small drum-shaped roller 1 is fixed at the central position of the bat-shaped bracket 3 and could be rotated freely. At this time, the half-moon shape shaft head of at the right end of the long mandrel 2 is riveted to the right base of the bat-shaped bracket 3, there is a half-moon shaft hole 13 at the left and right part of the bat-shaped bracket 3 respectively, refer to the FIGS. 5 and 3, the big drum-shaped roller 4 is fixed between the tilted lower parts of the bat-shaped bracket 3 through the short mandrel 5, the shaft heads at the two ends of the short mandrel 5 are formed into half-moon shape to connect with the same shape shaft hole 13 at the tilted lower part of the bat-shaped bracket 3, thus the big drum-shaped roller 4 is installed between the two bat-shaped brackets 3 and could be rotated freely, referencing the FIG. 6. The flat protruding stages are provided at the two sides at the central part of the bat-shaped bracket 3, referencing the FIG. 5, and there is also provided with the flat trapezia grooves corresponding to the flat trapezia protruding stages at the bat-shaped bracket 3, referencing the FIG. 7. Refer to the FIG. 8, the assembled element by small drum-shaped roller 1, bat-shaped bracket 3 and long mandrel 2 together with the big drum-shaped roller 4 and the short mandrel are arranged along the circumference direction in order. And then the flat grooves at the side panels 6 are aligned with the flat protruding stages on the bat-shaped bracket 3 and inserted with each other, the bearings 8, bushing 7 and central shaft 9 are mounted at the central part of the two side panels, referencing the FIG. 2, thus the universal wheel is formed, refer to FIG. 8. The universal wheel is fixed at the central part of the wheel carrier 10, which constructs the novel universal wheel, refer to FIG. 1. The carrier could be pushed to any direction by installing three or four universal wheels of the present invention at the lower part of the frame of the carrier.

What is claimed:

1. A kind of universal wheel, which consists of big and small drum-shaped rollers, bat-shaped brackets, long and short mandrels, side panels, bearings, a central shaft and a wheel carrier, which is characterized that the outer edge of the wheels is the wheel rim constituted by big and small drum-shaped rollers; a long mandrel is disposed at the center of the small drum-shaped roller and which is installed on the bat-shaped brackets, the lower parts of the left and right side of the bat-shaped brackets are each provided with one shaft hole respectively for fitting the short mandrels of the big drum-shaped roller, the big drum-shaped roller is fit over the short mandrel, the two ends of the big drum-shaped roller are provided with the grooves for inserting the left end or the right end of the bat-shaped brackets and the big drum-shaped roller is supported between the two bat-shaped brackets, the big and small drum-shaped rollers are supported by the bat-shaped brackets and constitute the wheel rim; the bearings are provided at the center of the side panels and with the center of the bearings as the central shaft installing wheel carrier there on.

2. The universal wheel as claimed in the claim 1, wherein the said left end of the long mandrel is the shaft head in half-moon shape fitted with the same shape shaft hole on the base at the left side of the bat-shaped bracket, and the shaft hole at the right base of the bat-shaped bracket is connected with the shaft head of the long mandrel and to be riveted together.

3. The universal wheel as claimed in the claim 1, wherein the shaft heads at the two ends of the short mandrel are machined into half-moon shape to be connected with the shaft holes in the same shape at the tilted lower part of the bat-shaped brackets.

4. The universal wheel as claimed in the claim 1, wherein the two sides at the middle part of the said bat-shaped brackets are provided with protruding stages in flat trapezia shape, and also the groove holes in flat trapezia shape are provided at the two side panels in the corresponding positions with the above flat protruding stages on the bat-shaped brackets, the flat trapezia groove holes at the two side panels are fixed with the same shape protruding stages at the bat-shaped brackets by insertion, and the wheel rim constructed by the big and small drum-shaped rollers together with bat-shaped bracket is fixed between the two side panels.

5. The universal wheel as claimed in the claim 1, wherein the said big and small drum-shaped rollers are three to thirty pairs.
